(19) United States
(12) Patent Application Publication
(10) Pub. No.: US 2004/0208572 A1
(43) Pub. Date: Oct. 21, 2004

(54) WDM optical transmission system with passive hub

(75) Inventors: Marcel F.C. Schemmann, BN Echt (NL); Venkatesh G. Mutalik, Manlius, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.W.

(21) Appl. No.: 10/029,809

(22) Filed: Dec. 27, 2001

(51) Int. Cl. H04J 14/02

(52) U.S. Cl. 398/82

(57) ABSTRACT

A method and apparatus for a wavelength division multiplexing (WDM) optical transmission system wherein the optical transmission system has an optical signal transmitter which functions as a passive hub, in which only optical signal processing is performed, while associated electronic signal processing is performed outside the passive hub. The passive hub includes upconverter devices that place the optical signal bands at frequencies that allow separation of the bands at a detector. The detectors are thus loaded with more than one wavelength at a time. The optical transmission signals are optically combined and/or amplified onto a single fiber that is fed to a headend device, where the wavelengths of the optical transmission signals are demultiplexed and fed to the receivers.

### BACKGROUND OF THE INVENTION

1. Technical Field

A method and apparatus for a wavelength division multiplexing (WDM) optical transmission system wherein the optical transmission system includes a passive hub in which only optical signal processing is performed, while associated electronic signal processing is performed outside the passive hub.

2. Related Art

Optical or fiber optic transmission systems are well known. A typical optical transmission system is comprised of a physical entity at a central location known as a head-end, with one or more trunk lines extending therefrom. Each trunk line has a plurality of feeder lines extending therefrom into subscriber areas, where each subscriber is attached via a line tap onto the feeder or service line. When the distances between the head-end and the subscriber areas are substantial, intervening distribution hubs may be located along the trunk lines to replenish the strength and quality of the signal being provided to the subscribers.

Throughout this document, the term wavelength division multiplexing (WDM) denotes using a single optical fiber to transmit several communications channels simultaneously whereby each channel transmits data utilizing a different wavelength of light. The term dense wavelength division multiplexing (DWDM) denotes WDM technology that utilizes several wavelengths of light that are relatively close to one another.

A typical optical WDM transmission system is shown in FIG. 1. The WDM transmission system 100 of FIG. 1 has one or more nodes 105, to which and from which optical signals 171, 111, respectively, are transmitted. In the typical WDM transmission system 100, each node 105, includes a plurality of wavelength control transmitters 110. Signals from the wavelength control transmitters 110 are transmitted on a fiber optic line to a distribution hub 120. The distribution hub 120 is used primarily to combine all the inputted optical signals 111, which signals 125 are then transmitted to a headend 140. The distribution hub 120 also typically includes a DWDM package 130 for processing the optical signals 125. The headend 140 includes a dense wavelength division demultiplexer (DWDD) 150 which processes the signals 125 and passes them to receivers 160 for further processing to derive the transmitted information. Typically, there is a corresponding receiver 160 for a corresponding wavelength of each signal.

One problem with the typical optical transmission system thus described is that the DWDM package 130 must be placed within the distribution hub 120, else it becomes susceptible to temperature variations which will affect the DWDM performance. When the temperature in any one nodes changes, the wavelength of that node can also change. This change in wavelength can then cause the wavelength of the optical signal from the node to coincide with or approach that from a second node. Thus, when the combined optical signal is detected at a distribution hub, there will be very strong noise (e.g., beat noise) caused by the superimposition of the first node's wavelength on that of the second node. One technique for addressing this problem is to use a DWDM wavelength stabilization technique as disclosed in U.S. Pat. No. 6,271,944 to Schemmann et al., incorporated herein by reference.

A second derivative problem with the typical optical transmission system is that the flexibility and capacity of the system are constrained by the temperature effects noted above.

It would be desirable, therefore, to provide an optical transmission system wherein the DWDM processing carried out at a distribution hub is essentially independent of temperature variations.

### SUMMARY OF THE INVENTION

It is a feature of the present invention to provide an optical transmission system with a passive hub, that is, a distribution hub wherein the signal processing is limited substantially to optical signal processing, while related electronic signal processing is performed elsewhere. The resultant optical transmission system is thus capable of temperature-independent operation, which effectively reduces or eliminates temperature-induced wavelength fluctuations in transmitted optical signals. The resultant optical transmission system also provides an increase in system capacity and flexibility.

In a first general aspect, the present invention provides an optical transmission system comprising: a plurality of optical signal transmitters for receiving RF signal inputs and transmitting optical signals, wherein each optical signal transmitter produces optical signals having a first characteristic wavelength; a plurality of optical transmission lines coupled to said optical signal transmitters and to at least one headend, said head end including at least one DWDM signal receiver; said at least one DWDM signal receiver having a second characteristic wavelength, said second characteristic wavelength corresponding to the first characteristic wavelength of the optical signal transmitter; an output from said at least one DWDM signal receiver; at least one information signal line coupled to said output of said at least one DWDM signal receiver; and wherein there is no distribution hub operationally coupled between said plurality of optical signal transmitters and said headend.

A second general aspect of the present invention is to provide a method of optically transmitting a signal comprising: receiving a plurality of RF signal inputs; transmitting a plurality of optical signals from at least one optical transmission source on a plurality of optical transmission lines, wherein each optical signal has a first characteristic wavelength; coupling at least one of said optical transmission lines to at least one headend, said headend including at least one DWDM signal receiver having a second characteristic wavelength, said second characteristic wavelength corresponding to the first characteristic wavelength of the optical signal transmitter; transmitting an output from said at least one DWDM signal receiver; coupling at least one information signal line to said output of said at least one DWDM signal receiver; and wherein no distribution hub is operationally coupled between said at least one of said optical transmission lines and said headend.

In a third general aspect, the present invention provides an optical transmission system comprising: a plurality of optical signal transmitters for receiving RF signal inputs and transmitting optical signals, wherein each optical signal transmitter produces optical signals having a first characteristic wavelength; a plurality of transmission clusters, each transmission cluster comprising at least one of said optical signal transmitters; a plurality of optical transmission lines coupled to said optical signal transmitters and to at least one headend, said head end including at least one DWDM signal receiver; said at least one DWDM signal receiver having a second characteristic wavelength, said second characteristic wavelength corresponding to the first characteristic wavelength of the optical signal transmitter; an output from said at least one DWDM signal receiver; at least one information signal line coupled to said output of said at least one DWDM signal receiver; and wherein there is no distribution hub operationally coupled between said plurality of optical signal transmitters and said headend.

The foregoing and other features and features of the invention will be apparent from the following more particular description of exemplary embodiments of the invention.

### BRIEF DESCRIPTION OF THE DRAWINGS

The exemplary embodiments of this invention will be described in detail, with reference to the accompanying figures, wherein like designations denote like elements, and wherein:

FIG. 1 is a diagram illustrating an optical transmission system of the related art;

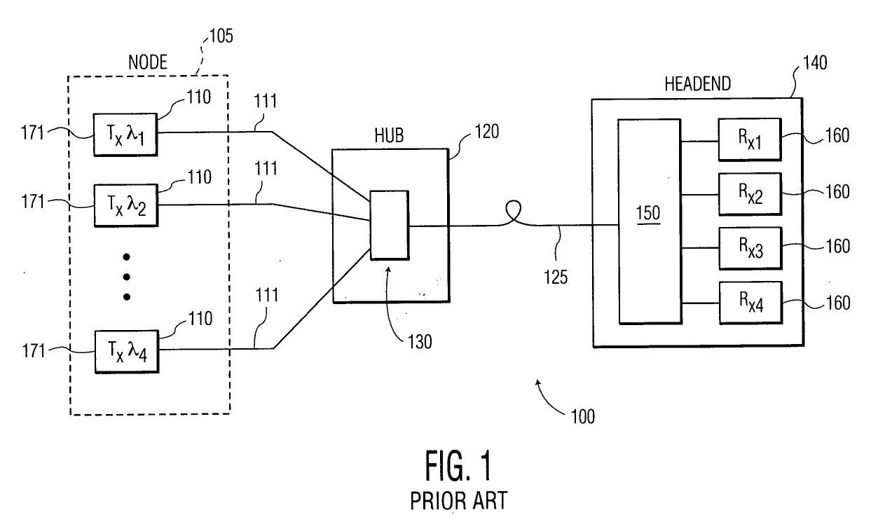

FIG. 2 is a diagram illustrating an optical transmission system in a first embodiment of the present invention; and

FIG. 3 is a diagram illustrating an optical transmission system in a second embodiment of the present invention.

### DESCRIPTION OF THE EMBODIMENTS

The following is a detailed explanation of the method and apparatus for a WDM optical transmission system including a passive hub in which only optical signal processing is performed, thus ensuring that the optical signals are not affected by temperature fluctuations.

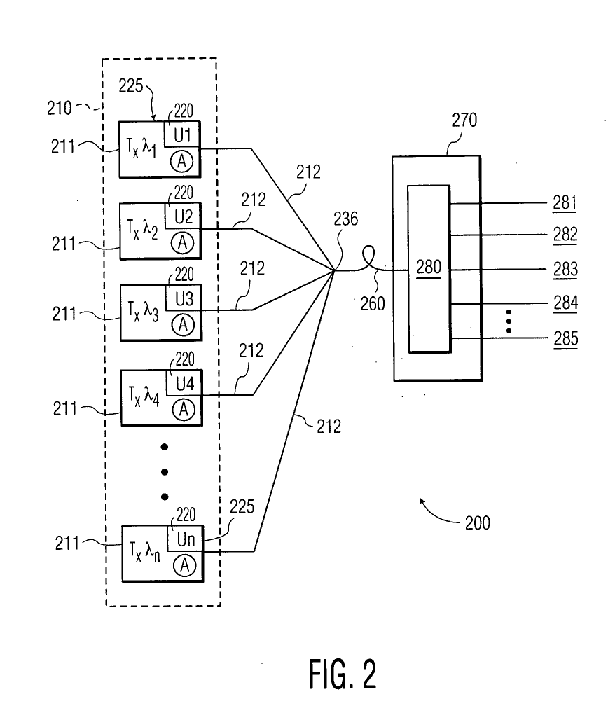

A first embodiment of a WDM optical transmission system 200 of the present invention is shown in FIG. 2 and comprises a cluster 210 of transmitters 220, a plurality of transmission fibers 212 operationally combined into a single transmission fiber 260, and a headend 270 including a receiver 280. Information is then removed from the receiver 280 as signals 281-285.

Each transmitter 220 operates at a particular wavelength, denoted by lambda 1, lambda 2, lambda 3, etc. Each transmitter 220 also includes an upconversion package 225, denoted by u1, u2, u3, etc., which upconverts the information in signal 211 to a particular frequency band. The upconverter may also be known by the term “signal re-spacer.” The frequency band will be unique for each upconverter. That is, the input to upconverter 1 will be upconverted to frequency band 1, the input to upconverter 12 will be upconverted to frequency band 2, and so forth. The width of the frequency bands is such that there is no overlap between the bands.

The upconverted signals are transmitted on fiber optic cables 212. In the embodiment of FIG. 2, the fiber optic lines 212 are shown as combined at a single point 235, and then the signals are transmitted along fiber optic line 260. Note that there is no distribution hub required in this embodiment. Moreover, the individual fiber optic lines 212 could be combined in a variety of configurations. Two fiber optic lines 212 could be combined at a first location, while two other fiber optic lines 212 could be combined at a second location. Subsequently, the two combined fiber optic lines could be combined at still a third location. This ability to combine fiber optic lines independent of location provides a great deal of flexibility, and also reduces the number of fiber optic lines necessary. The apparatus used to combine the fiber optic lines may be, inter alia, a known splitter/combiner apparatus.

Another feature of this optical transmission system is evident at the headend 270. Only a single receiver 280 is required at the headend 270. The receiver 280 has five outputs, in this illustrated embodiment. The receiver could have as many outputs as there are transmitters at cluster 210. A single receiver 280 can be utilized because the optical signals have been separated at their origin by the upconverters 225 in the transmitters 220 of cluster 210. The receiver may be of the type known in the art.

The wavelengths lambda 1, lambda 2, lambda 3, etc. should be far enough apart from each other that additional equipment, such as a WDM package, is not required to separate them. A separation of approximately 50 GHz is adequate, corresponding to a wavelength separation of c/50 GHz, where c is the velocity of light. The separation must just be sufficient that the wavelengths do not converge upon each other, which means that even a “sloppy” transmitter design is sufficient.

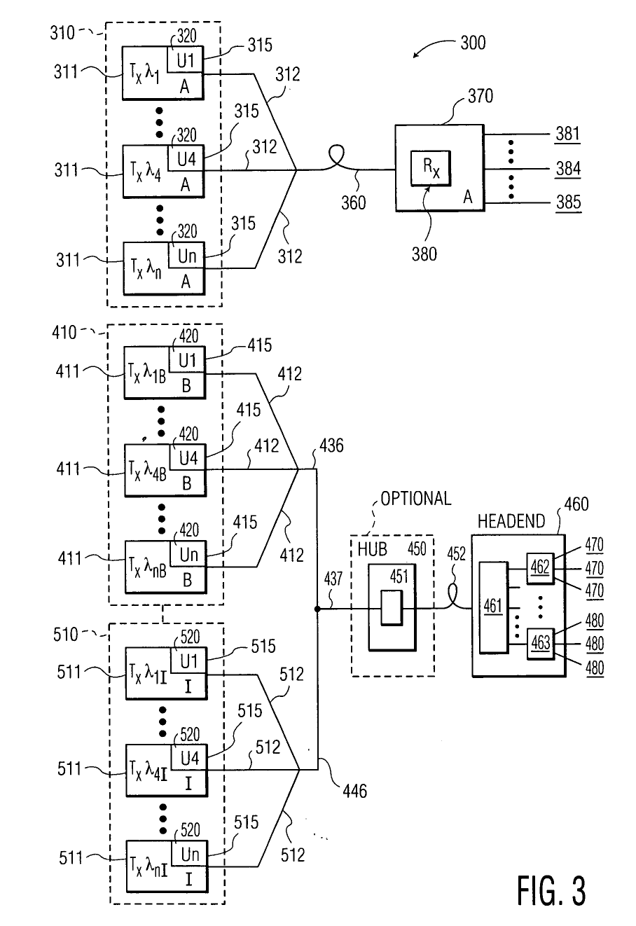

Referring now to FIG. 3, an expanded optical transmission system 300 is shown. The optical transmission system 300 includes a plurality of transmitter clusters 310, 410, 510 denoted as cluster A, cluster B, up to cluster I, where I is some independent number. Each transmitter cluster 310 is a logical cluster, that is, the transmitters 320, 420, 520 within a transmitter cluster are grouped logically, rather than by their physical proximity to each other.

Within a single transmission cluster, for example transmission cluster 310, there can be up to n transmitters 320 correspondingly to n wavelengths of light, where n is some number, commonly four, but which may be much higher. Each transmitter 320 includes an upconversion package 315, denoted by ul, u4, un, etc. The n transmitters 320 perform n unique upconversions, thus providing n upconverted signals 312 from transmission cluster A 320. These n upconverted signals can then be combined anywhere in the field, and a DWDM package is not required anywhere in this optical transmission system.

In similar fashion, transmission cluster B 410 provides n upconverted signals 412 from n upconversion packages 415. Transmission cluster C 510 also similarly produces n upconverted signals 512 from n upconversion packages 515. Each transmission cluster 310, 410, 510 may have a different number of transmitters, that is transmission cluster A 310 may have n transmitters while transmitter cluster B 410 may have m transmitters, where n and m are not equal.

However, the wavelengths associated with transmission cluster A 310 are different from those wavelengths associated with other transmission clusters. That is, lambda 1A is different from lambda 1B, which is different from lambda 1I, etc. After the upconversion of the signals, and because the wavelengths are different, the signals can be in the same band. Therefore, each wavelength can be combined into a single DWDM channel, Thus the capacity of the link is increased by x times, where x is calculated by summing Ni, where i is summed from 1 to the number of clusters, and Ni is the number of transmitters in each cluster.

Further, the DWDM does not need to be as closely spaced. In a typical transmission system, an extremely large number of DWDMs would now be required if the wavelengths were all different, and a DWDM was needed for each one of those wavelengths. In the embodiment of FIG. 3, however, there is really no requirement to have a DWDM. Rather, the DWDM 451 shown in distribution hub 450 is an option. Just as the fiber lines 412 from a single cluster 410 may be combined at will, as discussed supra, so too may the fiber lines 436, 446 coming from different clusters be combined at will.

Whether or not an optional distribution hub 450 is present, the optical signals are subsequently provided to headend 460 wherein the signals are processed in a dense wavelength division demultiplexer (DWDD) 461. In this embodiment, the DWDD is used to demultiplex the signal, after which the demultiplexed signals are passed to its own cluster receiver 462, 463. Each receiver then outputs its own stream of RF output 470, 480 in a usual manner.

The optical transmission system presented herein provides several benefits. First, the overall receiver count is decreased. Second, the transmitter design may be sloppy in that it need not have precise tolerances. Thirdly, the capacity of the overall optical transmission system is increased. Finally, overall flexibility is improved since field combination of signals is possible.

While this invention has been described in conjunction with the specific embodiments outlined above, it is evident that many alternatives, modifications and variations will be apparent to those skilled in the art. Accordingly, the exemplary embodiments of the invention as set forth above are intended to be illustrative, not limiting. Various changes may be made without departing from the spirit and scope of the invention as defined in the following claims.

What is claimed is:

1. An optical transmission system comprising:
a plurality of optical signal transmitters for receiving RF signal inputs and transmitting optical signals, wherein each optical signal produces optical signals having a first characteristic wavelength;
a plurality of optical transmission lines coupled to said optical signal transmitters and to at least one headend, said head end including at least one DWDM signal receiver;
said at least one DWDM signal receiver having a second characteristic wavelength, said second characteristic wavelength corresponding to the first characteristic wavelength of the optical signal transmitter;
an output from said at least one DWDM signal receiver;
at least one information signal line coupled to said output of said at least one DWDM signal receiver; and
wherein there is no distribution hub operationally coupled between said plurality of optical signal transmitters and said headend.

2. The optical transmission system of claim 1, wherein said plurality of optical signal transmitters produce a plurality of optical signals, and wherein said plurality of optical signals are freely combined.

3. The optical transmission system of claim 1, wherein each optical signal transmitter includes an upconverter.

4. The optical transmission system of claim 3, wherein each upconverter is characterized by a frequency band, and further wherein said frequency band is unique to that said upconverter.

5. The optical transmission system of claim 3, wherein there is no overlap between frequency bands corresponding to each of said upconverters.

6. The optical transmission system of claim 2, wherein said plurality of optical signals are combined with a splitter/combiner apparatus.

7. The optical transmission system of claim 1, wherein the output from a first of said at least one DWDM receivers and the output from a second of said at least one DWDM receivers are signals having different wavelengths, and wherein said different wavelengths do not converge.

8. A method of optically transmitting a signal comprising:
receiving a plurality of RF signal inputs;
transmitting a plurality of optical signals from at least one optical transmission source on a plurality of optical transmission lines, wherein each optical signal has a first characteristic wavelength;
coupling at least one of said optical transmission lines to at least one headend, said headend including at least one DWDM signal receiver having a second characteristic wavelength, said second characteristic wavelength corresponding to the first characteristic wavelength of the optical signal transmitter;
transmitting an output from said at least one DWDM signal receiver;
coupling at least one information signal line to said output of said at least one DWDM signal receiver; and
wherein no distribution hub is operationally coupled between said at least one of said optical transmission lines and said headend.

9. The method of claim 8, wherein the step of receiving the plurality of RF signal inputs includes receiving the plurality of RF signal inputs into a plurality of optical signal transmitters.

10. The method of claim 8, further comprising the step of combining a plurality of said optical transmission lines together at a location between the transmission source and the headend.

11. The method of claim 8, further comprising the step of upconverting the plurality of optical signals before the step of transmitting the plurality of optical signals from at least one transmission source.

12. An optical transmission system comprising:
a plurality of optical signal transmitters for receiving RF signal inputs and transmitting optical signals, wherein each optical signal transmitter produces optical signals having a first characteristic wavelength;
a plurality of transmission clusters, each transmission cluster comprising at least one of said optical signal transmitters;
a plurality of optical transmission lines coupled to said optical signal transmitters and to at least one headend, said head end including at least one DWDM signal receiver;
said at least one DWDM signal receiver having a second characteristic wavelength, said second characteristic wavelength corresponding to the first characteristic wavelength of the optical signal transmitter;
an output from said at least one DWDM signal receiver;
at least one information signal line coupled to said output of said at least one DWDM signal receiver; and
wherein there is no distribution hub operationally coupled between said plurality of optical signal transmitters and said headend.

13. The optical transmission system of claim 12, wherein said plurality of optical signal transmitters produce a plurality of optical signals, and wherein said plurality of optical signals are freely combined.

14. The optical transmission system of claim 12, wherein each optical signal transmitter includes an upconverter.

15. The optical transmission system of claim 14, wherein each upconverter is characterized by a frequency band, and further wherein said frequency band is unique to that said upconverter.

16. The optical transmission system of claim 14, wherein there is no overlap between frequency bands corresponding to each of said upconverters.

17. The optical transmission system of claim 13, wherein said plurality of optical signals are combined with a splitter/combiner apparatus.

18. The optical transmission system of claim 12, wherein said headend includes a single receiver.

19. The optical transmission system of claim 12, wherein said headend includes a plurality of receivers.

20. The optical transmission system of claim 12, wherein said headend includes at least one dense wavelength division demultiplexer (DWDD) device.

21. The optical transmission system of claim 12, wherein the output from a first of said at least one DWDM receivers and the output from a second of said at least one DWDM receivers are signals having different wavelengths, and wherein said different wavelengths do not converge.
